(19) United States
(12) Patent Application Publication
(10) Pub. No.: US 2003/0204762 A1
(43) Pub. Date: Oct. 30, 2003

(54) Dynamic adjustment method for power consumption in a computer system

(76) Inventors: Ming-Chieh Lee, Lungtan Shiang (TW); Po-Tin Liu, Dashi Jen (TW); Yu-Hui Chen, Gueishan Shiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/246,054

(22) Filed: Sep. 18, 2002

(30) Foreign Application Priority Data
Apr. 25, 2002 (TW) 91108554

(51) Int. Cl. G06F 1/32

(52) U.S. Cl. 713/322

(57) ABSTRACT

A method of dynamically adjusting power consumption for a computer system. The method includes the steps of setting a parameter table in the computer system and checking the computer system to obtain a parameter. The parameter is compared with the parameter table to obtain a result. According to the result and the parameter table, the clock throttling ratio of a CPU in the computer system is adjusted.

### BACKGROUND OF THE INVENTION

1. Field of the Invention

The present invention relates to a dynamic adjustment method for power consumption in a computer system, especially a method related to computing power consumption to dynamically adjust clock throttling ratio of a central processing unit (CPU), for computer systems working steadily in battery mode.

2. Description of the Related Art

Notebook computers have the same advantages as desktop PCs, with further advantages of smaller size and portability. Notebook computers do have problems related to limited power supply when in battery mode. To increase the battery life of a notebook computer, it is possible to increase the capacity of the battery, but this will increase the volume and weight thereof, impacting portability. Reducing the power consumption of devices in the notebook computer, providing longer battery life with the same battery power, is preferable.

In a computer system, power saving function of many devices can be promoted. Taiwan Patent number 265,431 discloses a power saving method and device for hard drive storage, reducing the angular velocity of the hard drive servomotor to reduce the power consumption thereof. However, in a computer system, the CPU is the most important device and expends considerable power, deeply affecting a notebook computer, not only in consumption of power, but also by generating heat that causes system instability and errors. To exhaust the heat, large heat sinks and fans are required, again impacting portability.

### SUMMARY OF THE INVENTION

An object of the present invention is to provide a method of making a computer system stable, by dynamically adjusting CPU clock throttling ratio, further controlling its power consumption, and extending battery life.

Another object of the present invention is to solve problems of using a desktop CPU in a notebook computer, thereby reducing costs, including problems of high power consumption and unacceptable heat production.

To achieve these objects, the present invention provides a method of dynamic adjustment, comprising setting a parameter table in a computer system, checking the computer system and obtaining a first parameter, comparing the first parameter with a second parameter to determine whether power consumption is going up or down, obtaining a third parameter from the predetermined parameter table, comparing the first parameter with the third parameter to adjust the CPU clock throttling ratio, and replacing the first parameter with the second parameter and the adjusted clock throttling ratio value, and checking the computer system again.

### BRIEF DESCRIPTION OF THE DRAWINGS

The present invention can be more fully understood by reading the subsequent detailed description in conjunction with the examples and references made of the accompanying drawings, wherein:

FIG. 1 is a flowchart according to the embodiment of the present invention.

### DETAILED DESCRIPTION OF THE INVENTION

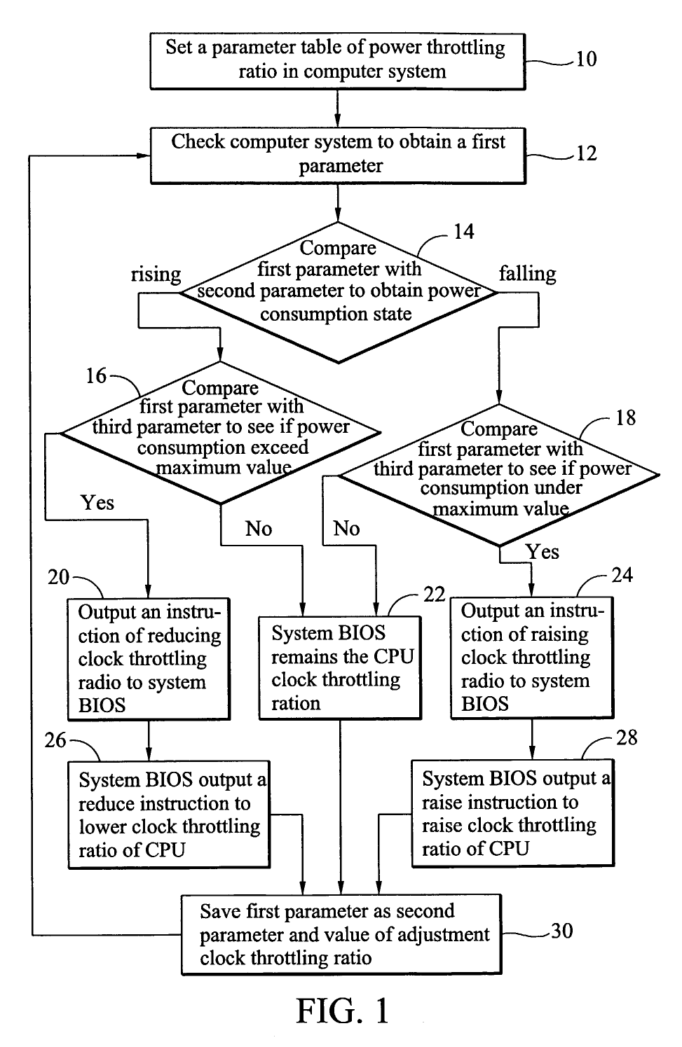

The present invention discloses a method of dynamic adjustment of power consumption for a computer system. FIG. 1 shows the following steps.

In Step 10, a parameter table of power throttling ratio is predetermined and stored in a computer system with CPU or system BIOS. For example, the predetermined parameter table is stored in a microcontroller of a computer system, such as an embedded controller or keyboard controller, the parameter table comprising power throttling ratio. In Table 1, a power throttling ratio parameter table is listed.

TABLE 1
Power throttling ratio parameter table

| CPU clock | CPU clock | Maximum power | Minimum power |
|---|---|---|---|
| throttling | throttling | of raising | of lowering |
| ratio steps | ratio | state | state |
| 1 | 50% | >50 W | <39 W |
| 2 | 37.5% | >60 W | <49 W |
| 3 | 25% | >70 W | <59 W |
| 4 | 12.5% | >80 W | <69 W |

Table 1 shows parameters including CPU clock throttling ratio steps, CPU clock throttling ratio, maximum power of raising state and minimum power of lowering state. The parameter table also includes the predetermined parameter of system power consumption, for example 49W. Table 1 lists examples, not intended to limit the invention, and values of the parameters can be changed according to various systems.

Step 12 checks the computer system to obtain a first parameter. Power consumption of the computer system is measured and a first parameter is obtained by the microcontroller, that is, system power consumption value. The first parameter can be obtained via monitoring the power consumption of the system in a specific period, resulting in the power consumption value.

The steps of obtaining the first parameter include monitoring the current/voltage analog signals of the system, outputting the current/voltage analog signals to the microcontroller, which performs analog to digital conversion to obtain a related digital parameter. The analog signal is the voltage or current of the computer system or current of the CPU, and the analog signal converted to the related digital signal is a voltage or current parameter of the computer system or current of the CPU. Due to the constant nature of the CPU core voltage parameter, the voltage value times the current value of the computer system or the voltage value times the current value of the CPU, followed by several samplings and obtaining subsequent averages provides a first parameter, the average value avoiding the effect of voltage or current pulses. Computation of the power consumption can be performed by the microcontroller and saved as a first parameter therein.

Four methods of checking power consumption of the computer system are described herein without intending to limit the invention to these methods. The methods are described as follows:

Method 1 monitors the voltage of the computer system by an external voltage monitor circuit (for example, voltage of a battery, voltage of external power), and monitors the current of the computer system by an external current monitor circuit, to obtain the power consumption value by, for example, connecting the voltage monitor point and current monitor point to the microcontroller to perform signal processing.

In method 2: Due to the constant nature of the CPU core voltage, an external monitor circuit monitors the current of the CPU, obtaining the power consumption value using the CPU operation voltage and the monitored current.

In Method 3, when a notebook computer working in battery mode, power consumption of the system is limited. Microcontroller can obtain average voltage and current of the battery by the system management bus (SMB), and obtain the power consumption value for the system. This process also reduces the sampling rate of monitor.

In Method 4, since the computer system is operated in battery mode, the voltage of the battery does not change much in a short period. Thus, the microcontroller in the computer system can read the average current of the battery by the system management bus, further obtaining the power consumption value for the system.

Step 14 compares the first parameter with the second parameter to obtain the current power consumption state. The first parameter represents the current power consumption obtained by step 12. The second parameter represents the former power consumption, at startup, and the second parameter is a preset value, according to the parameter table predetermined in Step 10. If the first parameter is greater than the second parameter means the power consumption is in a raising state, and the method goes to step 16. Otherwise, if the first parameter is smaller than the second parameter, the power consumption is in a lowering state, and the method goes to step 18.

In Step 16, the microcontroller gets the maximum power of rising state according to the third parameter and compares with the first parameter, to see if the power consumption exceeds the predetermined maximum, wherein the third parameter is based on the CPU clock throttling ratio steps related to the maximum power of raising state in the parameter table respectively. If the first parameter is greater than the maximum corresponding to the third parameter in the parameter table, the method goes to step 20. On the contrary, if the first parameter is not greater than the maximum parameter in the parameter table, the method goes to step 22.

For example, when the first parameter is 65W(Watt) and the second parameter is 55W, the power consumption is in a raising state. The second parameter (55W) is related to Step 1 of the CPU clock throttling ratio, and corresponds to 50% CPU clock throttling ratio of raising state, since 55W is in the range of 50W to 60W. The third parameter according to the second parameter (55W) is 1. Because the first parameter (65W) is greater than the maximum parameter (60W) corresponding to the CPU clock throttling ratio step 2 in the parameter table, the third parameter is modified from 1 to 2, which is raised from the step of the second parameter, and corresponds to 37.5% CPU clock throttling ratio of raising state. Then the method goes to step 20.

For another example, when the first parameter is 58W and the second parameter is 55W, the CPU clock throttling ratio steps corresponding to the first and second parameters are the same and in the step 1. The CPU clock throttling ratio corresponding to the step 1 is 50%. Since the first parameter (58W) is smaller than the maximum power (60W) of the CPU clock throttling ratio step 2 in the parameter table, the system power consumption is stable and the third parameter is maintained. Then the method goes to step 22.

In Step 18, the microcontroller get the minimum power of lowering state according to the third parameter and compares with the first parameter, to see if power consumption is under the predetermined minimum, the third parameter is based on the CPU clock throttling ratio steps in the parameter table related to the value of minimum power of lowering state. If the first parameter is smaller than minimum parameter corresponding to the third parameter in the parameter table, the method goes to step 24. If the first parameter is not smaller than the minimum parameter in the parameter table, the method goes to step 22.

For example, when the first parameter is 48W and the second parameter is 65W, the power consumption is in a lowering state. In the second step of the CPU clock throttling ratio according to the second parameter (65W) in the maximum power column of the table, the corresponding CPU clock throttling ratio of lowering state is 37.5%. The third parameter according to the second parameter (65W) is 2. As the first parameter is smaller than the minimum parameter (49W) corresponding to the CPU clock throttling ratio step 2 in the parameter table, the third parameter is modified from 2 to 1, which is reduced from the step of the second parameter, and the corresponding CPU clock throttling ratio of lowering state is 50%. Then the method goes to step 24.

For another example, when the first parameter is 62W and the second parameter is 65W, the CPU clock throttling ratio steps corresponding to the first and second parameters are the same and in the step 2. The CPU clock throttling ratio corresponding to the step 2 is 37.5%. The third parameter according to the second parameter (65W) is 2. Since the first parameter (62W) is not smaller than the minimum parameter (49W) of the CPU clock throttling ratio step 2 in the parameter table, the system is stable and the third parameter is maintained. Then the method goes to step 22.

Step 20 outputs an instruction of reducing clock throttling ratio to the system BIOS. The system is in a raising state of power consumption, so the microcontroller outputs an instruction of reducing clock throttling ratio to the system BIOS, and stores the related CPU clock throttling ratio step, and the method goes to step 26. For example, when the first parameter is 65W, the second parameter is 55W, the power consumption is in a raising state, the first parameter (65W) related to CPU clock throttling ratio of raising state is 37.5%, and the second parameter (55W) related to CPU clock throttling ratio of the CPU in raising state is 50%. The microcontroller outputs an instruction of reducing clock throttling ratio to the system BIOS according to a parameter table, changing the CPU clock throttling ratio from 50% to 37.5%.

In Step 22, an instruction of adjustment clock throttling ratio won't be outputted to the system BIOS. The system is stable, so the CPU keeps its clock throttling ratio, and the method goes to step 30. Since power consumption is stable, the microcontroller does not output an adjustment instruction to the system BIOS, so the CPU maintaining the clock throttling ratio.

In Step 24, the system is under a lowering state of power consumption, so the microcontroller outputs an instruction of raising clock throttling ratio to the system BIOS, and stores the related CPU clock throttling ratio step, then goes to step 28. For example, when the first parameter is 48W and the second parameter is 65W, power consumption is in a lowering state. The CPU clock throttling ratio of lowering state related to the first parameter (48W) is 50%, and the CPU clock throttling ratio of lowering state related to the second parameter (65W) is 37.5%. Thus the microcontroller outputs an instruction of raising clock throttling ratio to the system BIOS according to a parameter table, changing the CPU clock throttling ratio from 37.5% to 50%.

In Step 26, the system BIOS outputs a reducing instruction to lower the CPU clock throttling ratio according to the instruction of reducing clock throttling ratio, the throttle lowers the clock throttling ratio to a preset value according to the reducing instruction, and the method goes to step 30. The throttle can be in a CPU or a chipset of the computer system. For example, when the first parameter is 65W and the second parameter is 55W, the CPU clock throttling ratio will be changed from 50% to 37.5% (from Step 1 to Step 2 of the CPU clock throttling ratio).

In Step 28 the system BIOS outputs a raising instruction to raise the CPU clock throttling ratio according to the instruction of raising clock throttling ratio, the throttle raises the CPU clock throttling ratio to a preset value according to the raising instruction, and the method goes to step 30. For example, when the first parameter is 48W, the second parameter is 65W, and the CPU clock throttling ratio is changed from 37.5% to 50% (from Step 2 to Step 1 of the CPU clock throttling ratio).

Step 30 saves the first parameter as the second parameter and the value of adjustment clock throttling ratio. The microcontroller makes the first parameter replace the second parameter, and saves the second parameter in the microcontroller, and updates these three parameters, then repeats step 12.

The present invention has the advantage of allowing a desktop CPU to replace mobile CPU in a notebook computer, and lowering costs of notebook computers. Additionally, this invention solves some problems caused by desktop CPUs, and extends battery life of the notebook computer.

Finally, while the invention has been described by way of example and in terms of the above preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for dynamic adjustment of power consumption in computer systems having a system BIOS and a CPU, the method comprising the steps of:
setting a parameter table in the computer system;
checking the computer system to obtain a first parameter;
comparing the first parameter with the parameter table, obtaining a first result, the first result having a related maximum value and minimum value;
outputting a first adjustment instruction to the system BIOS according to the first result and the parameter table;
the system BIOS adjusting CPU clock throttling ratio according to the first adjustment instruction; and
saving the first parameter as a second parameter.

2. The method for dynamic adjustment of power consumption in computer systems according to claim 1, further comprising, after adjusting the CPU clock throttling ratio and saving the second parameter, the steps of:
checking the computer system to obtain a first parameter again;
comparing the first parameter with the second parameter, obtaining a second result;
outputting a second adjustment instruction to the system BIOS according to the second result and the parameter table;
the system BIOS adjusting CPU clock throttling ratio according to the second adjustment instruction; and
saving the first parameter as a second parameter.

3. The method for dynamic adjustment of power consumption in computer systems according to claim 2, further comprising the step of:
comparing the first parameter with the first result, when the first parameter is greater than the maximum of the first result, the second result is a raising state, referring to the second result and the parameter table and then reducing the CPU clock throttling ratio.

4. The method for dynamic adjustment of power consumption in computer systems according to claim 2, further comprising the step of:
comparing the first parameter with the first result, when the first parameter is smaller than the minimum of the first result, the second result is a lowering state, referring to the second result and the parameter table and then raising CPU clock throttling ratio.

5. The method for dynamic adjustment of power consumption in computer systems according to claim 2, further comprising the step of:
comparing the first parameter with the first result, when the first parameter is within the range of the first result, and maintaining the CPU clock throttling ratio.

6. The method for dynamic adjustment of power consumption in computer systems according to claim 1, wherein the parameter table is preset in a microcontroller of the computer system.

7. The method for dynamic adjustment of power consumption in computer systems according to claim 6, wherein the method of checking the computer system to obtain the first parameter further comprises the steps of:
checking an analog signal with a check circuit of the computer system; and
the check circuit outputting the analog signal to the microcontroller for conversion and evaluation to obtain the first parameter.

8. The method for dynamic adjustment of power consumption in computer systems according to claim 6, wherein the microcontroller compares the first parameter with the parameter table to obtain the first result.

9. The method for dynamic adjustment of power consumption in computer systems according to claim 6, wherein the first parameter and the second parameter are saved in the microcontroller.

10. A method for dynamic adjustment of power consumption in computer systems having a system BIOS, a CPU and a microcontroller, the method comprising the steps of:
setting a power throttling ratio parameter table in the microcontroller;
checking power consumption of the computer system, obtaining a first parameter from the microcontroller;
the microcontroller comparing the first parameter with the power throttling ratio parameter table to obtain a power consumption state;
the microcontroller comparing the first parameter with a related third parameter's maximum and minimum according to the power throttling ratio parameter table, and outputting a first adjustment instruction to the system BIOS;
the system BIOS adjusting the CPU clock throttling ratio according to the first adjustment instruction; and
the microcontroller saving the first parameter as a second parameter.

11. The method for dynamic adjustment of power consumption in computer systems according to claim 10, wherein adjustment of the CPU clock throttling ratio and saving the result as the second parameter further comprises the steps of:
checking the computer system to obtain the first parameter again;
the microcontroller comparing the first parameter with the second parameter obtain a second result;
the microcontroller outputting a second adjustment instruction to the system BIOS according to the second result and the power throttling ratio parameter table;
the system BIOS adjusting CPU clock throttling ratio according to the second adjustment parameter; and
the microcontroller saving the first parameter as the second parameter.

12. The method for dynamic adjustment of power consumption in computer systems according to claim 11, further comprising the steps of:
comparing the first parameter with the first result by the microcontroller according to the power throttling ratio parameter table, when the first parameter is greater than the maximum of the first result, and the second result is a raising state;
the microcontroller outputting an instruction of reducing clock throttling ratio to the system BIOS according to the power throttling ratio parameter table; and
the system BIOS reducing CPU clock throttling ratio according to the instruction of reducing clock throttling ratio.

13. The method for dynamic adjustment of power consumption in computer systems according to claim 11, further comprising the steps of:
the microcontroller comparing the first parameter with the first result according to the power throttling ratio parameter table, when the first parameter is smaller than the minimum of the first result, and the second result is a lowering state;
the microcontroller outputting an instruction of raising clock throttling ratio to the system BIOS according the power throttling ratio parameter table; and
the system BIOS raising the CPU clock throttling ratio according to the instruction of raise clock throttling ratio.

14. The method for dynamic adjustment of power consumption in computer systems according to claim 11, further comprising the microcontroller comparing the first parameter with the result according to the power throttling ratio parameter table, when the first parameter is within the range of the first result, the system BIOS maintaining the CPU clock throttling ratio.

15. The method for dynamic adjustment of power consumption in computer systems according to claim 11, the method of checks computer system power consumption further comprising the steps of:
an extra added voltage check circuit and an extra added current check circuit in the computer system checking a voltage signal and a current signal of the computer system, respectively; and
sending of the voltage signal and the current signal to the microcontroller by the extra added voltage check circuit and the extra added current check circuit for signal conversion and evaluation to obtain the first parameter.

16. The method for dynamic adjustment of power consumption in computer systems according to claim 15, wherein the checked current signal is obtained from the CPU.

17. The method for dynamic adjustment of power consumption in computer systems according to claim 11, the method of checking computer system power consumption further comprising the steps of:
the microcontroller obtaining a battery voltage signal and a battery current signal of the computer system, wherein the battery current signal is obtained via a system management bus of the computer system; and
the microcontroller converting and evaluating the battery voltage signal and the battery current signal to obtain the first parameter.

18. The method for dynamic adjustment of power consumption in computer systems according to claim 10, further comprising the system BIOS adjusting a throttle of the computer system according to the first adjustment instruction for adjustment of the CPU clock throttling ratio.

19. The method for dynamic adjustment of power consumption in computer systems according to claim 11, further comprising the system BIOS controlling a throttle of the computer system adjust the CPU clock throttling ratio according to the second adjustment instruction.
